(19) United States
(12) Patent Application Publication
(10) Pub. No.: US 2026/0122212 A1
(43) Pub. Date: Apr. 30, 2026

(54) METHOD FOR PROVIDING THREE-DIMENSIONAL SCREEN, AND ELECTRONIC DEVICE SUPPORTING SAME

(71) Applicant: Samsung Electronics Co., Ltd., Suwon-si (KR)

(72) Inventors: Seungchan LEE, Suwon-si (KR); Byunghwa LEE, Suwon-si (KR); Minkyu JUNG, Suwon-si (KR)

(21) Appl. No.: 19/429,873

(22) Filed: Dec. 22, 2025

Related U.S. Application Data
(63) Continuation of application No. PCT/KR2024/009406, filed on Jul. 3, 2024.

(30) Foreign Application Priority Data
Jul. 4, 2023 (KR) 10-2023-0086384
Jul. 14, 2023 (KR) 10-2023-0091605

(51) Int. Cl. H04N 13/363; G06F 3/04815; H04N 13/383; H04N 13/398

(52) U.S. Cl. CPC H04N 13/363; G06F 3/04815; H04N 13/383; H04N 13/398

(57) ABSTRACT

An electronic device may comprise: a display configured to support a 3D screen; an inertial sensor; at least one processor comprising processing circuitry; and a memory for storing instructions. The instructions, when executed by the at least one processor individually or collectively, may cause the electronic device to: display a first screen in a 3D form through the display; detect a rotation axis, a rotation direction, and a rotation angle of the electronic device through the inertial sensor based on the electronic device being rotated while the first screen is displayed; and display, through the display, the first screen rotated based on the rotation axis, the rotation direction, and the rotation angle of the electronic device, and a 3D space that has not been displayed through the display.

### CROSS-REFERENCE TO RELATED APPLICATIONS

This application is a continuation of International Application No. PCT/KR2024/009406 designating the United States, filed on Jul. 3, 2024, in the Korean Intellectual Property Receiving Office and claiming priority to Korean Patent Application Nos. 10-2023-0086384, filed on Jul. 4, 2023, and 10-2023-0091605, filed on Jul. 14, 2023, in the Korean Intellectual Property Office, the disclosures of each of which are incorporated by reference herein in their entireties.

### BACKGROUND

### Field

The disclosure relates to a method of providing a three-dimensional screen and an electronic device supporting the same.

### Description of Related Art

An electronic device may provide a three-dimensional screen (e.g., a three-dimensional stereoscopic image). For example, an electronic device may provide a three-dimensional screen using a method using glasses (e.g., shutter glasses, polarized glasses) or a glasses-free method without wearing glasses.

The glasses-free method may be a method of implementing a three-dimensional screen using a lenticular lens or a parallax barrier disposed in front of a display to allow different image information to be seen by the left/right eyes of a user.

The above-described information may be provided as related art for the purpose of helping understanding of the disclosure. No assertion or determination is made as to whether any of the foregoing is applicable as background art in relation to the disclosure.

### SUMMARY

Embodiments of the disclosure may provide a method of providing a three-dimensional screen and an electronic device supporting the same that may extend a three-dimensional spatial experience by rotating a three-dimensional screen currently displayed through a display of an electronic device based on rotation of the electronic device and displaying a three-dimensional space that was hidden (e.g., not displayed) before rotation of the electronic device through the display.

An electronic device according to an example embodiment may include: a display configured to support a 3D screen, an inertial sensor, at least one processor, comprising processing circuitry, and memory storing instructions. The instructions may, when executed by the at least one processor individually or collectively, cause the electronic device to: display a first screen in a 3D form through the display; detect, through the inertial sensor, a rotation axis, a rotation direction, and a rotation angle of the electronic device based on the electronic device being rotated while the first screen is displayed; and display, through the display, the first screen rotated based on the rotation axis, the rotation direction, and the rotation angle of the electronic device and a 3D space which has not been displayed through the display.

According to an example embodiment, a method of providing a three-dimensional screen in an electronic device may include: displaying a first screen in a 3D form through a display included in the electronic device and supporting a 3D screen; detecting, through an inertial sensor of the electronic device, a rotation axis, a rotation direction, and a rotation angle of the electronic device based on the electronic device being rotated while the first screen is displayed; and displaying, through the display, the first screen rotated based on the rotation axis, the rotation direction, and the rotation angle of the electronic device and a 3D space which has not been displayed through the display.

According to an example embodiment, in a non-transitory computer-readable medium storing computer-executable instructions, the computer-executable instructions may, when executed by at least one processor, comprising processing circuitry, individually or collectively, of an electronic device, cause an electronic device to: display a first screen in a 3D form through a display included in the electronic device and supporting a 3D screen; detect, through an inertial sensor of the electronic device, a rotation axis, a rotation direction, and a rotation angle of the electronic device based on the electronic device being rotated while the first screen is displayed; and display, through the display, the first screen rotated based on the rotation axis, the rotation direction, and the rotation angle of the electronic device and a 3D space which has not been displayed through the display.

According to various example embodiments, a method of providing a three-dimensional screen and an electronic device supporting the same may extend a three-dimensional spatial experience by rotating a three-dimensional screen currently displayed through a display of an electronic device based on rotation of the electronic device and displaying a three-dimensional space which has not been displayed before rotation of the electronic device through the display.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a block diagram illustrating an example electronic device in a network environment according to various embodiments.

FIG. 2 is a block diagram illustrating an example configuration of an electronic device according to various embodiments.

FIG. 3 is a flowchart illustrating an example method of providing a three-dimensional screen according to various embodiments.

FIG. 4 is a diagram illustrating an example in which an electronic device rotates about a vertical axis according to various embodiments.

FIG. 5 is a diagram illustrating an example in which an electronic device rotates about a horizontal axis according to various embodiments.

FIG. 6 is a diagram illustrating an example rotated first screen and a 3D space according to various embodiments.

FIG. 7 is a diagram illustrating an example method of providing a three-dimensional screen using a first scheme according to various embodiments.

FIG. 8 is a diagram illustrating an example method of providing a three-dimensional screen using a first scheme according to various embodiments.

FIG. 9 is a diagram illustrating an example method of providing a three-dimensional screen using a second scheme according to various embodiments.

FIG. 10 is a diagram illustrating an example method of providing a three-dimensional screen using a second scheme according to various embodiments.

FIG. 11 is a diagram illustrating an example method of providing a three-dimensional screen according to various embodiments.

FIG. 12 is a flowchart illustrating an example method of providing information in a 3D space according to various embodiments.

FIG. 13 is a diagram illustrating an example method of providing information in a 3D space according to various embodiments.

FIG. 14 is a diagram illustrating an example method of providing information in a 3D space according to various embodiments.

FIG. 15 is a diagram illustrating an example method of providing information in a 3D space according to various embodiments.

FIG. 16 is a diagram illustrating an example method of providing information in a 3D space according to various embodiments.

FIG. 17 is a flowchart illustrating an example method of providing information in a 3D space according to various embodiments.

FIG. 18 is a diagram illustrating an example method of providing information in a 3D space according to various embodiments.

FIG. 19 is a diagram illustrating an example method of providing information in a 3D space according to various embodiments.

FIG. 20 is a diagram illustrating an example optical configuration for a 3D screen according to various embodiments.

FIG. 21 is a diagram illustrating an example method of controlling an object included in a first screen according to various embodiments.

FIG. 22 is a diagram illustrating an example method of controlling an object included in a first screen according to various embodiments.

### DETAILED DESCRIPTION

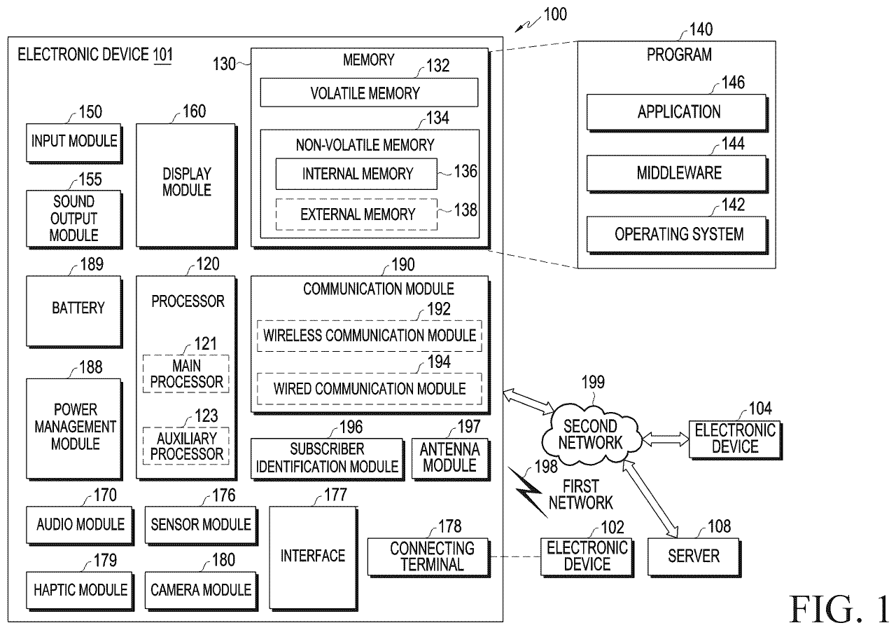

FIG. 1 is a block diagram illustrating an example electronic device 101 in a network environment 100 according to various embodiments.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to an embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121. Thus, the processor 120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a 5G network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a 4G network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the mmWave band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna.

The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic devices are not limited to those described above.

It should be appreciated that various embodiments of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), the element may be coupled with the other element directly (e.g., wiredly), wirelessly, or via a third element.

As used herein, the term “module” may include a unit implemented in hardware, software, or firmware, or any combination thereof, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

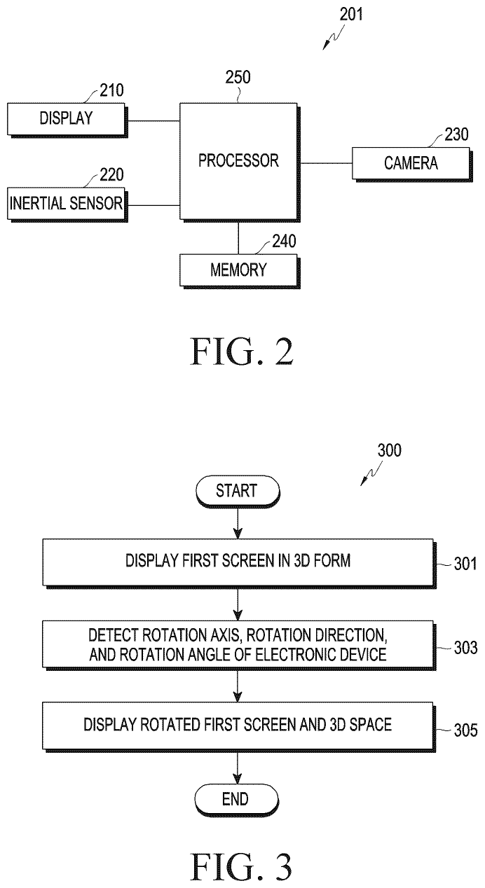

FIG. 2 is a block diagram illustrating an example configuration of an electronic device 201 according to various embodiments.

Referring to FIG. 2, in an embodiment, an electronic device 201 may be the electronic device 101 of FIG. 1.

In an embodiment, the electronic device 201 may include a display 210, an inertial sensor 220, a camera 230, memory 240, and/or a processor (e.g., including processing circuitry) 250.

In an embodiment, the display 210 may be the display module 160 of FIG. 1.

In an embodiment, the display 210 may be a display capable of supporting a three dimensional (hereinafter also referred to as “3D”) screen.

In an embodiment, the display 210 may be a display capable of supporting (e.g., displaying) a three-dimensional screen using a glasses-free method.

In an embodiment, the display 210 may display a three-dimensional screen using a lenticular lens (also referred to as a “lenticular screen”) disposed in front of a display panel. For example, the display 210 may separate left/right binocular screens (e.g., left/right binocular images) using a lenticular lens. A three-dimensional screen may be provided by the left/right screens separated by the lenticular lens being respectively illustrated to the user's left/right eyes.

In an embodiment, the display 210 may display a three-dimensional screen using a parallax barrier disposed in front of a display panel. For example, the display 210 may display a three-dimensional screen using an optical configuration (e.g., an optical plate) in which a barrier and an aperture are disposed at regular intervals.

In an embodiment, the display 210 may be a light field display. For example, the display 210 may display a three-dimensional screen by generating a light field represented by a vector distribution of light in space (e.g., intensity and direction of light) through a flat display and an optical element.

In an embodiment, the display 210 may be a display capable of displaying a 3D screen from multiple viewpoints of a user. For example, the display 210 may be a display capable of displaying multiple left/right screens corresponding to each of multiple viewpoints. For example, the display 210 may display a 3D screen from multiple viewpoints by being implemented in a tilted form of RGB pixels of the display 210 panel and a lenticular lens (e.g., a form in which the direction in which the RGB pixels of the display 210 panel are disposed and the direction in which the lenticular lens is disposed form a predetermined angle). For example, when the display 210 includes an optical configuration in which a barrier and an aperture are disposed at regular intervals, the display 210 may display a three-dimensional screen corresponding to the user's viewpoint (e.g., capable of minimizing/reducing crosstalk where left/right screens appear overlapped to each of the user's left/right eyes) by moving the optical configuration according to the user's viewpoint.

However, the method by which the display 210 displays a three-dimensional screen using a glasses-free method is not limited to the various examples.

In an embodiment, the display 210 may be a display capable of supporting a 2D screen and a 3D screen. For example, when the display 210 includes a lenticular lens, the display 210 may display a mutually switchable 2D screen (or 2D mode) and 3D screen (3D mode) by changing (e.g., adjusting) the refractive index of the lenticular lens. For example, when the display 210 includes an optical configuration in which a barrier and an aperture are disposed at regular intervals, the display 210 may display a mutually switchable (e.g., capable of mode switching between 2D mode and 3D mode) 2D screen and 3D screen by turning the barrier on/off.

In an embodiment, the inertial sensor 220 (inertial measurement unit (IMU) sensor) may detect (or sense) movement of the electronic device 201 and/or posture of the electronic device 201. For example, the inertial sensor 220 may include a gyro sensor, an acceleration sensor, and/or a geomagnetic sensor capable of detecting movement of the electronic device 201 and/or posture of the electronic device 201.

In an embodiment, the inertial sensor 220 may be included in the sensor module 176 of FIG. 1.

In an embodiment, the inertial sensor 220 may detect rotation of an electronic device 201. For example, the inertial sensor 220 may detect a rotation axis on which the electronic device 201 rotates, a direction in which the electronic device 201 rotates, and/or an angle where the electronic device 201 rotates. For example, the inertial sensor 220 may obtain sensor data for obtaining (e.g., identifying) a rotation axis on which the electronic device 201 rotates, a direction in which the electronic device 201 rotates, and/or an angle where the electronic device 201 rotates.

In an embodiment, the camera 230 may be the camera module 180 of FIG. 1.

In an embodiment, the camera 230 may be an eye tracking (ET) camera. For example, the camera 230 may obtain an image using infrared light. The obtained image may be used for detection and tracking of a user's pupil. For example, the camera 230 may be a camera capable of obtaining an image for obtaining (or detecting) a direction in which a user's eye gazes relative to a direction in which the electronic device 201 (e.g., the display 210) faces (hereinafter referred to as “gaze direction”) and/or a position (or area) where the user's eye gazes within the display 210 (hereinafter referred to as “gaze position” or “gaze point”).

In an embodiment, the memory 240 may be the memory 130 of FIG. 1.

In an embodiment, the memory 240 may store information for performing an operation of providing a 3D screen. Information stored by the memory 240 for performing an operation of providing a 3D screen is described below.

In an embodiment, the processor 250 may be the processor 120 of FIG. 1, and the description above of the processor 120 applies equally to the processor 250.

In an embodiment, the processor 250 may include various processing circuitry and control overall operations for providing a 3D screen. In an embodiment, the processor 250 may include one or more processors performing operations for providing a 3D screen. Operations performed by the processor 250 to provide a 3D screen are described in greater detail below with reference to FIGS. 3 to 22.

In FIG. 2, the electronic device 201 is illustrated as including the display 210, an inertial sensor 220, a camera 230, memory 240, and/or a processor 250, but the disclosure is not limited thereto. For example, the electronic device 201 may further include some of the components illustrated in FIG. 1. For example, the electronic device 201 may further include a depth sensor such as a time of flight (TOF) for obtaining a distance to a user's eye. For example, the electronic device 201 may further include a sound output module 155 and a haptic module 179.

FIG. 3 is a flowchart 300 illustrating an example method of providing a three-dimensional screen according to various embodiments.

Referring to FIG. 3, in operation 301, in an embodiment, the processor 250 may display (e.g., control an electronic device or display to display) a first screen in a 3D form through the display 210. As used herein, the term “the processor may” is used interchangeably with the phrase “the processor may cause or control” and is intended to cover situations where the processor itself and/or another element under the control of the processor performs the recited operation.

In an embodiment, the first screen of operation 301 (hereinafter also referred to as “first screen”) may refer to a screen displayed through the display 210 before the electronic device 201 rotates. For example, the first screen may be a home screen, a lock screen, or an execution screen of an application displayed through the display 210 before the electronic device 201 rotates (or before performing operation 303 to be described below). For example, the first screen may be a screen including a home screen, a lock screen, or an execution screen of an application displayed through the display 210 before the electronic device 201 rotates (or before performing operation 303 to be described below). For example, the first screen may be a screen displayed through the entire area of the display 210 before displaying a 3D space to be described below.

In an embodiment, the first screen in 3D form in operation 301 may be a screen displayed parallel to a surface of the display 210 (e.g., a surface of the display 210 exposed to the outside). For example, a three-dimensional space forming the first screen in 3D form may be parallel to the surface of the display 210.

In an embodiment, the processor 250 may display the first screen in 3D form through the display 210 when capable of tracking a user's eyes (e.g., both eyes of the user). For example, the processor 250 may display the first screen in 2D form as the first screen in 3D form through the display 210 based on identifying that the user's eyes may be tracked while displaying the first screen in 2D form.

In an embodiment, the processor 250 may display the first screen in 3D form through the display 210 when the user's eyes may be recognized (e.g., may display the first screen in 2D form as the first screen in 3D form). For example, the processor 250 may display the first screen in 3D form through the display 210 based on identifying (or detecting) a direction in which a user's eyes gaze relative to a direction in which the electronic device 201 (e.g., the display 210) faces (hereinafter referred to as “gaze direction”) and/or a position (or area) where the user's eyes gaze within the display 210 (hereinafter referred to as “gaze position”) based on an image obtained through a camera 230. For example, the processor 250 may display left/right binocular screens so that the first screen in 3D form corresponding to the gaze direction and/or gaze position is provided (e.g., illustrated) to a user based on the gaze direction and/or gaze position being identified based on an image obtained through a camera 230.

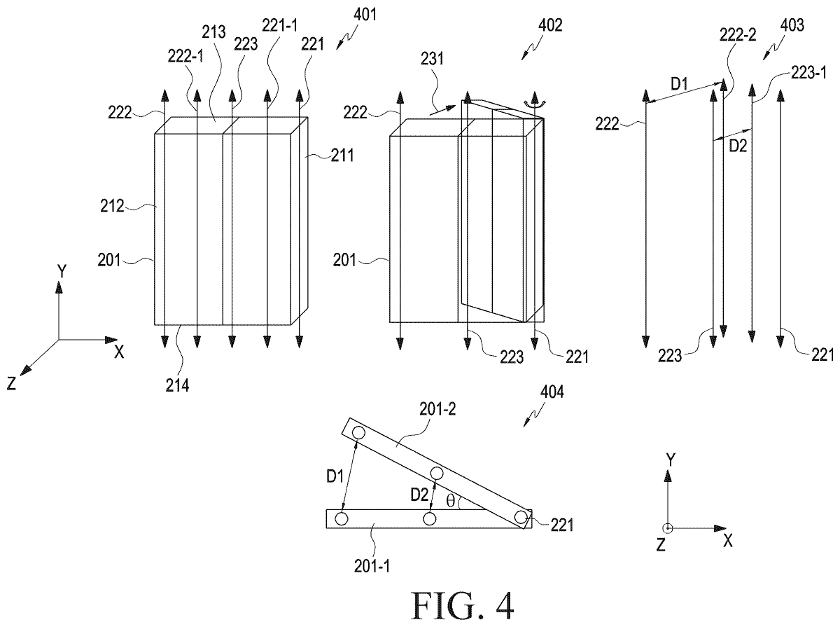

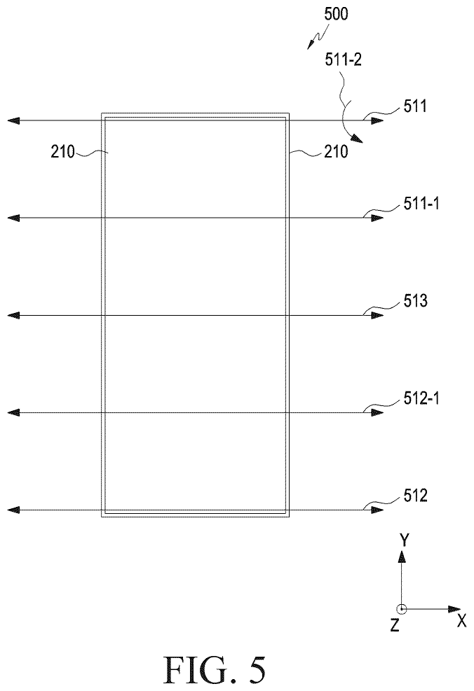

In operation 303, in an embodiment, the processor 250 may detect a rotation axis, a rotation direction, and a rotation angle of the electronic device 201 through the inertial sensor 220 based on the electronic device 201 being rotated while the first screen is displayed. For example, the processor 250 may detect rotation of the electronic device 201 through the inertial sensor 220 while the first screen is displayed in 3D form. The processor 250 may detect an axis on which the electronic device 201 rotates (hereinafter also referred to as “rotation axis”), a direction in which the electronic device 201 rotates with respect to the rotation axis of the electronic device 201 (hereinafter also referred to as “rotation direction”), and an angle where the electronic device 201 rotates (hereinafter also referred to as “rotation angle”) through the inertial sensor 220 based on the electronic device 201 being rotated. Hereinafter, rotation of the electronic device 201 is described in greater detail with reference to FIGS. 4 and 5.

FIG. 4 is a diagram illustrating an example in which the electronic device 201 rotates about a vertical axis according to various embodiments.

Referring to FIG. 4, in an embodiment, as illustrated in reference numerals 401 and 402, the electronic device 201 may rotate about a vertical axis (e.g., an axis parallel to the Y axis). For example, in reference numeral 401, reference numeral 211 may represent a right surface of an electronic device 201, reference numeral 212 may represent a left surface of the electronic device 201, reference numeral 213 may represent an upper surface of the electronic device 201, and reference numeral 214 may represent a lower surface of the electronic device 201. The electronic device 201 may rotate in a clockwise direction (e.g., a direction indicated by arrow 231) (or clockwise) with respect to (or centered on) an axis 221 (hereinafter referred to as “right axis”) traversing the center of the right surface 211 in a vertical direction. However, the disclosure is not limited thereto. For example, the electronic device 201 may rotate clockwise or counterclockwise with respect to an axis 222 (hereinafter referred to as “left axis”) traversing the center of the left surface 212 in a vertical direction. For example, the electronic device 201 may rotate clockwise or counterclockwise with respect to an axis 223 (hereinafter referred to as “vertical center axis”) traversing the center of the electronic device 201 in a vertical direction. For example, the electronic device 201 may rotate about a vertical axis (e.g., axis 221-1) between the right axis 221 and the vertical center axis 223 or a vertical axis (e.g., axis 222-1) between the left axis 222 and the vertical center axis 223.

In an embodiment, in reference numerals 403 and 404, when the electronic device 201 rotates by an angle θ with respect to the right axis 221, a distance between the left axis 222 before rotation of the electronic device 201 and the left axis 222-2 after rotation of the electronic device 201 is D1, a distance between the vertical center axis 223 before rotation of the electronic device 201 and the vertical center axis 223-1 after rotation of the electronic device 201 is D2, and the right axis 221 may be maintained before/after rotation of the electronic device 201.

In an embodiment, the processor 250 may detect a rotation axis, a rotation direction, and/or a rotation angle of the electronic device 201 through an inertial sensor 220. For example, in reference numerals 401 to 404, when the electronic device 201 rotates by a predetermined angle θ counterclockwise with respect to the right axis 221, the processor 250 may identify through the inertial sensor 220 that the rotation axis of the electronic device 201 is the right axis, the rotation direction is clockwise, and the rotation angle is the predetermined (e.g., specified) angle θ.

FIG. 5 is a diagram 500 illustrating an example in which the electronic device 201 rotates about a horizontal axis according to various embodiments.

Referring to FIG. 5, in an embodiment, the electronic device 201 may rotate clockwise or counterclockwise with respect to a horizontal axis (e.g., an axis parallel to the X axis) as illustrated in FIG. 5. For example, the electronic device 201 may rotate clockwise (e.g., clockwise when viewed from +X) or counterclockwise (e.g., counterclockwise when viewed from +X) with respect to an axis 511 (hereinafter referred to as “upper axis”) traversing the center of the upper surface (e.g., the upper surface 213 of FIG. 4) of the electronic device 201 in a left-right direction. For example, the electronic device 201 may rotate clockwise or counterclockwise with respect to an axis 512 (hereinafter referred to as “lower axis”) traversing the center of the lower surface (e.g., the lower surface 214 of FIG. 4) of the electronic device 201 in a left-right direction. For example, the electronic device 201 may rotate clockwise or counterclockwise with respect to an axis 513 (hereinafter referred to as “horizontal center axis”) traversing the center of the electronic device 201 in a left-right direction. For example, the electronic device 201 may rotate about a horizontal axis (e.g., axis 511-1) between the upper axis 511 and the horizontal center axis 513 or a horizontal axis (e.g., axis 512-1) between the lower axis 512 and the horizontal center axis 513.

In an embodiment, the processor 250 may detect a rotation axis, a rotation direction, and/or a rotation angle of the electronic device 201 through an inertial sensor 220. For example, when the electronic device 201 rotates by a predetermined angle in a counterclockwise direction indicated by arrow 511-2 with respect to the upper axis 511, the processor 250 may identify through the inertial sensor 220 that the rotation axis of the electronic device 201 is the upper axis, identify that the rotation direction is counterclockwise, and identify that the rotation angle is the predetermined angle.

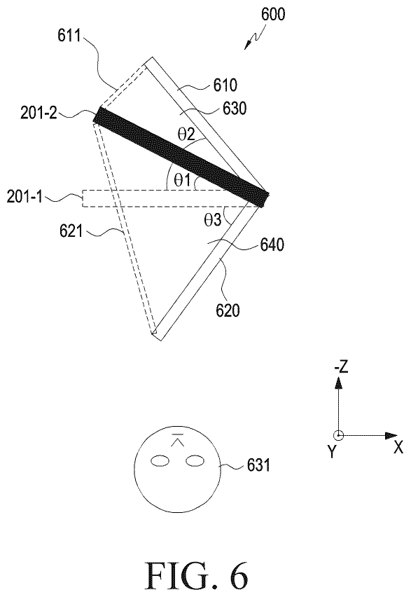

In operation 305, in an embodiment, the processor 250 may display, through the display 210, the first screen rotated based on the rotation axis, the rotation direction, and the rotation angle of the electronic device 201 and a 3D space which has not been displayed through the display. For example, the processor 250 may display, through the display 210, a screen (hereinafter, a screen displayed after the electronic device 201 is rotated is referred to as “second screen”) including the first screen rotated based on the rotation axis, the rotation direction, and the rotation angle of the electronic device 201 and a 3D space that was not visible (or hidden) before the electronic device 201 rotates. Hereinafter, operation 305 is described in greater detail with reference to FIG. 6.

FIG. 6 is a diagram 600 illustrating an example rotated first screen and a 3D space according to various embodiments.

Referring to FIG. 6, in an embodiment, when the electronic device 201 is rotated, the processor 250 may rotate the first screen (e.g., the first screen in 3D form) such that the first screen is positioned in a front direction in which the display 210 faces (hereinafter referred to as “front direction of the electronic device 201 or the display 210” or “first direction”) or a rear direction which is an opposite direction to the front direction (hereinafter referred to as “rear direction of the electronic device 201 or the display 210” or “second direction”) (or reverse direction or the front direction of the electronic device 201).

In an embodiment, an operation of rotating the first screen in 3D form or an operation of displaying the rotated first screen in 3D form may include an operation of controlling the display 210 so that the first screen in 3D form (e.g., the first screen in 3D form) appears rotated to a user 631.

In an embodiment, when the electronic device 201 is rotated with respect to a first rotation axis, the processor 250 may rotate the first screen with respect to the first rotation axis such that the first screen is positioned in the rear direction of the electronic device 201 (or the display 210). Hereinafter, a method of rotating the first screen with respect to an axis corresponding to the rotation axis of the electronic device 201 (e.g., an axis identical to the rotation axis of the electronic device 201) as a rotation axis such that the first screen is positioned in the rear direction of the electronic device 201 (or the display 210) is referred to as a “first scheme” or “negative scheme.”

In an embodiment, the first scheme may be a method of rotating the first screen by an angle greater than the rotation angle of the electronic device 201 in the same first direction as the direction in which the electronic device 201 rotates with respect to the first rotation axis while the first screen is positioned in the rear direction of the electronic device 201 when the electronic device 201 is rotated in a first direction with respect to the first rotation axis. However, the disclosure is not limited thereto. For example, the first scheme may also be a method of rotating the first screen by an angle greater than the rotation angle of the electronic device 201 in an opposite direction to the direction in which the electronic device 201 rotates with respect to the first rotation axis while the first screen is positioned in the rear direction of the electronic device 201 when the electronic device 201 is rotated in a first direction with respect to the first rotation axis.

In an embodiment, when rotating the first screen using the first scheme, the processor 250 may rotate the first screen by an angle greater than the rotation angle of the electronic device 201 based on the rotation angle of the electronic device 201.

In an embodiment, when rotating the first screen using the first scheme, the processor 250 may determine (e.g., calculate) the rotation angle of the first screen using Equation 1 below.

$$Rotation angle of first screen = k 1 * ( rotation angle of electronic device ) \qquad [ Equation 1 ]$$

In an embodiment, in Equation 1, k1 may be a constant value greater than 1.

In an embodiment, when rotating the first screen using the first scheme, the processor 250 may determine (e.g., calculate) the rotation angle of the first screen using Equation 2 below.

$$Rotation angle of first screen = rotation angle of electronic device + a \qquad [ Equation 2 ]$$

In an embodiment, in Equation 1, a may be an angle greater than 0.

However, when rotating the first screen using the first scheme, the method of determining the rotation angle of the first screen based on the rotation angle of the electronic device 201 is not limited to the example. For example, the processor 250 may determine the rotation angle of the first screen based on the rotation angle of the electronic device 201 and the rotation speed of the electronic device 201 (e.g., angular velocity where the electronic device 201 rotates). For example, the processor 250 may determine the rotation angle of the first screen such that the faster the rotation speed of the electronic device 201, the larger the rotation angle of the first screen (e.g., such that increased k1 or increased a is applied to Equation 1 or Equation 2). For example, the processor 250 may determine the rotation angle of the first screen such that the slower the rotation speed of the electronic device 201, the smaller the rotation angle of the first screen.

In an embodiment, the processor 250 may rotate the first screen at the same speed as the rotation speed of the electronic device. However, the disclosure is not limited thereto. For example, the processor 250 may rotate the first screen at a slower speed than the rotation speed of the electronic device.

In an embodiment, when rotating the first screen using the first scheme, the processor 250 may determine the rotation axis and rotation direction of the first screen based on the rotation direction and rotation axis of the electronic device 201. For example, when rotating the first screen using the first scheme, if the electronic device 201 rotates clockwise with respect to the right axis (e.g., when the electronic device 201 rotates such that the left axis moves away from the user with respect to the right axis), the processor 250 may determine to rotate the first screen clockwise with respect to the right axis. For example, when rotating the first screen using the first scheme, if the electronic device 201 rotates counterclockwise with respect to the right axis (e.g., when the electronic device 201 rotates such that the left axis moves closer to the user with respect to the right axis), the processor 250 may determine to rotate the first screen clockwise with respect to the right axis.

In an embodiment, when rotating the first screen using the first scheme, the processor 250 may display, through the display 210, a 3D space which has not been displayed (or hidden) before rotation of the electronic device 201 (hereinafter referred to as “3D space” or “hidden 3D space”) together with the rotated first screen.

In an embodiment, in FIG. 6, reference numeral 201-1 may represent the electronic device 201 displaying the first screen before rotation (e.g., the first screen displayed in 3D form parallel to a plane formed by the X axis and Y axis through the display 210 before the electronic device 201 is rotated). When the electronic device 201 is rotated by a predetermined angle θ1 clockwise with respect to the right axis of the electronic device 201 as in reference numeral 201-2, the processor 250 may display, through the display 210, the first screen 610 rotated by a rotation angle θ2 greater than the predetermined angle θ1 using the first scheme. In an embodiment, when the first screen is rotated, a space 630 (hereinafter referred to as “negative space”) may be formed between the first screen 610 after rotation and the electronic device 201-2 after rotation in the rear direction of the electronic device 201-2 after rotation. The processor 250 may display, through the display 210, a 3D space 611 that appears by rotation of the first screen within the negative space 630 (e.g., included in the negative space 630) together with the rotated first screen 610.

In an embodiment, the 3D space that appears by rotation of the electronic device 201 (or rotation of the first screen) may be a space in 3D form excluding the first screen within the second screen displayed through the display 210 after rotation of the electronic device 201.

In an embodiment, the 3D space that appears by rotation of the electronic device 201 (or rotation of the first screen) may be a space formed based on the rotated first screen (e.g., corners of the rotated first screen) and the second screen displayed after rotation of the electronic device 201 (e.g., corners of the rotated second screen). For example, the 3D space that appears by rotation of the electronic device 201 (or rotation of the first screen) may be a space formed between three corners excluding a corner corresponding to the rotation axis of the first screen among four corners of the rotated first screen and three corners excluding a corner corresponding to the rotation axis of the first screen among four corners of the second screen displayed after rotation of the electronic device 201.

In an embodiment, the 3D space that appears by rotation of the electronic device 201 (or rotation of the first screen) may be a space where depth is formed centered on a surface formed by corners of the rotated first screen and corners of the second screen displayed after rotation of the electronic device 201. For example, the 3D space that appears by rotation of the electronic device 201 (or rotation of the first screen) may be a space where depth is formed with respect to a surface connecting a first corner excluding a corner corresponding to the rotation axis of the first screen among two corners of the first screen parallel to the rotation axis of the first screen, a second corner excluding a corner corresponding to the rotation axis of the first screen among two corners of the second screen parallel to the rotation axis of the first screen, and endpoints of the first corner and endpoints of the second corner.

In an embodiment, as illustrated in FIG. 6, when the first screen is rotated using the first scheme, a 3D space 611 may appear based on the first screen 610 after rotation and the electronic device 201 after rotation (e.g., the second screen displayed on the display 210 after rotation).

In an embodiment, the processor 250 may display information (e.g., one or more objects, images, text, window) through the display 210 in the 3D space 611 (or on a surface forming the reference of the 3D space 611). The operation of the processor 250 displaying information in the 3D space 611 is described below in detail.

In an embodiment, when the electronic device 201 is rotated with respect to a first rotation axis, the processor 250 may rotate the first screen with respect to the first rotation axis such that the first screen is positioned in the front direction of the electronic device 201 (or the display 210). Hereinafter, a method of rotating the first screen with respect to a rotation axis corresponding to the rotation axis of the electronic device 201 (e.g., an axis identical to the rotation axis of the electronic device 201) such that the first screen is positioned in the front direction of the electronic device 201 (or the display 210) is referred to as a “second scheme” or “positive scheme.”

In an embodiment, the second scheme may be a method of rotating the first screen by an angle greater than the rotation angle of the electronic device 201 in the same first direction as the direction in which the electronic device 201 rotates with respect to the first rotation axis while the first screen is positioned in the front direction of the electronic device 201 when the electronic device 201 is rotated in a first direction with respect to the first rotation axis. However, the disclosure is not limited thereto. For example, the second scheme may also be a method of rotating the first screen by an angle greater than the rotation angle of the electronic device 201 in an opposite direction to the direction in which the electronic device 201 rotates with respect to the first rotation axis while the first screen is positioned in the front direction of the electronic device 201 when the electronic device 201 is rotated in a first direction with respect to the first rotation axis.

In an embodiment, when rotating the second screen using the second scheme, the processor 250 may rotate the second screen by an angle greater than the rotation angle of the electronic device 201 based on the rotation angle of the electronic device 201.

In an embodiment, when rotating the first screen using the second scheme, the processor 250 may determine (e.g., calculate) the rotation angle of the first screen using Equation 3 below.

$$Rotation angle of first screen = k 2 * ( rotation angle of electronic device ) \qquad [ Equation 3 ]$$

In an embodiment, in Equation 3, k2 may be a constant value greater than 1. In an embodiment, k2 in Equation 3 may be the same as k1 in Equation 1. However, without limitations thereto, k2 in Equation 3 may be different from k1 in Equation 1.

In an embodiment, when rotating the first screen using the second scheme, the processor 250 may determine (e.g., calculate) the rotation angle of the first screen using Equation 4 below.

$$Rotation angle of first screen = rotation angle of electronic device + b \qquad [ Equation 4 ]$$

In an embodiment, in Equation 4, b may be an angle greater than 0. In an embodiment, b in Equation 4 may be the same as a in Equation 2. However, without limitations thereto, b in Equation 4 may be different from a in Equation 2.

However, when rotating the first screen using the second scheme, the method of determining the rotation angle of the first screen based on the rotation angle of the electronic device 201 is not limited to the example. For example, the processor 250 may determine the rotation angle of the first screen based on the rotation angle of the electronic device 201 and the rotation speed of the electronic device 201 (e.g., angular velocity where the electronic device 201 rotates).

In an embodiment, when rotating the first screen using the second scheme, the processor 250 may determine the rotation axis and rotation direction of the first screen based on the rotation direction and rotation axis of the electronic device 201. For example, when rotating the first screen using the second scheme, if the electronic device 201 rotates clockwise with respect to the right axis (e.g., when the electronic device 201 rotates such that the left axis moves away from the user with respect to the right axis), the processor 250 may determine to rotate the first screen counterclockwise with respect to the right axis. For example, when rotating the first screen using the second scheme, if the electronic device 201 rotates counterclockwise with respect to the right axis (e.g., when the electronic device 201 rotates such that the left axis moves closer to the user with respect to the right axis), the processor 250 may determine to rotate the first screen counterclockwise with respect to the right axis.

In an embodiment, when rotating the first screen using the second scheme, the processor 250 may display, through the display 210, a 3D space which has not been displayed before rotation of the electronic device 201 together with the rotated first screen.

In an embodiment, in FIG. 6, when the electronic device 201 is rotated by a predetermined angle θ1 clockwise with respect to the right axis of the electronic device 201 as in reference numeral 201-2, the processor 250 may display, through the display 210, the first screen 620 rotated counterclockwise by a rotation angle θ3 greater than the predetermined angle θ1 using the second scheme. In an embodiment, when the first screen is rotated, a space 640 (hereinafter referred to as “positive space”) may be formed between the first screen 620 after rotation and the electronic device 201-2 after rotation in the front direction of the electronic device 201-2 after rotation. The processor 250 may display, through the display 210, a 3D space 621 that appears by rotation of the first screen within the positive space 640 (e.g., included in the positive space 640) together with the rotated first screen 620.

In an embodiment, as illustrated in FIG. 6, when the first screen is rotated using the second scheme, a 3D space 621 may appear based on the first screen 610 after rotation and the electronic device 201 after rotation (e.g., the second screen displayed on the display 210 after rotation).

In an embodiment, the processor 250 may display information through the display 210 in the 3D space 621 and/or on a surface of the 3D space 621.

In an embodiment, the processor 250 may determine (or select) a scheme for rotating the first screen from among the first scheme and the second scheme based on user input (e.g., user input through a settings menu, or user input for an object for selecting the first scheme or second scheme).

In an embodiment, the processor 250 may determine (or select) a scheme for rotating the first screen from among the first scheme and the second scheme based on the type of application executed (e.g., currently executing) on the electronic device 201.

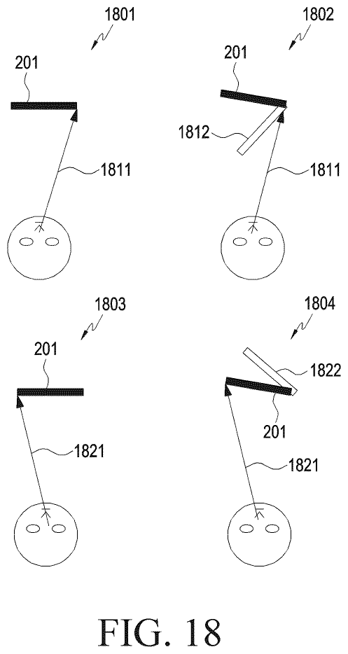

In an embodiment, the processor 250 may determine (or select) a scheme for rotating the first screen from among the first scheme and the second scheme based on the rotation axis, rotation direction, and gaze position of the electronic device 201. This is described in greater detail below with reference to FIG. 18.

In an embodiment, when additional rotation of the electronic device 201 is detected while displaying the rotated first screen and 3D space, the processor 250 may rotate the rotated first screen based on the additional rotation and hide the 3D space again (e.g., make it invisible) or display an extended 3D space through the display 210. For example, in FIG. 6, when the electronic device 201 is rotated to be positioned at the pre-rotation position as in reference numeral 201-1 while displaying the rotated first screen 610 and 3D space 611, the processor 250 may control the display 210 to display the first screen before rotation of the electronic device 201 and hide the 3D space 611 (e.g., so that the 3D space 611 is not visible). For example, in FIG. 6, when the electronic device 201 additionally rotates clockwise with respect to the right axis while displaying the rotated first screen 610 and 3D space 611, the processor 250 may display the additionally clockwise rotated first screen and the extended 3D space through the display 210.

In an embodiment, in the examples, the case where the electronic device 201 rotates with respect to the left axis (e.g., left axis 222) or right axis (e.g., right axis 221) has been described, but the disclosure is not limited thereto.

In an embodiment, when the electronic device 201 is rotated with respect to an axis other than any one of the right axis, left axis, upper axis, and lower axis, the processor 250 may determine that the electronic device 201 has been rotated with respect to an axis that is parallel to the axis on which the electronic device 201 was rotated and closest in distance to the axis on which the electronic device 201 was rotated among the right axis, left axis, upper axis, and lower axis.

In an embodiment, when the electronic device 201 is rotated with respect to a vertical axis (e.g., axis 221-1) between the right axis 221 and the vertical center axis 223 (or the vertical center axis 223), the processor 250 may perform the same operations as when the electronic device 201 is rotated with respect to the right axis 221. For example, when the electronic device 201 rotates by a predetermined angle clockwise with respect to axis 221-1, the processor 250 may perform operations applied when the electronic device 201 rotates by the predetermined angle clockwise with respect to the right axis 221.

In an embodiment, when the electronic device 201 is rotated with respect to a vertical axis (e.g., axis 222-1) between the left axis 222 and the vertical center axis 223, the processor 250 may perform the same operations as when the electronic device 201 is rotated with respect to the left axis 222.

In an embodiment, when the electronic device 201 is rotated with respect to a horizontal axis (e.g., axis 511-1) between the upper axis 511 and the horizontal center axis 513 (or the horizontal center axis 513), the processor 250 may perform the same operations as when the electronic device 201 is rotated with respect to the upper axis 511.

In an embodiment, when the electronic device 201 is rotated with respect to a horizontal axis (e.g., axis 512-1) between the lower axis 512 and the horizontal center axis 513, the processor 250 may perform the same operations as when the electronic device 201 is rotated with respect to the lower axis 512.

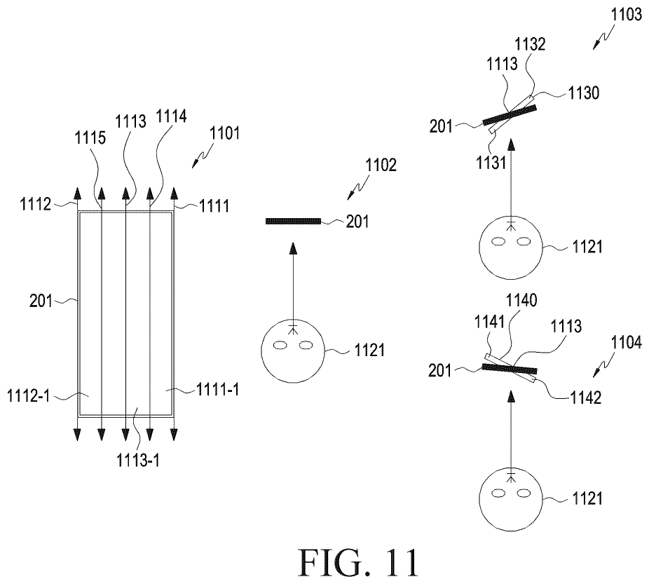

However, without limitations thereto, additional examples are described in greater detail below with reference to FIG. 11.

Referring back to FIG. 3, in an embodiment, the processor 250 may perform operations 301 to 305 while tracking a user's eyes.

In an embodiment, when the user's eyes are not tracked while performing operations 301 to 305 (e.g., when the user's eyes move outside the field of view range of the camera 230), the processor 250 may display the first screen in 2D form through the display 210 instead of the first screen in 3D form that was displayed through the display 210. For example, when the user's eyes are not tracked, the processor 250 may display the first screen in 2D form and a 2D area representing the 3D space through the display 210 using perspective (e.g., perspective drawing) instead of the first screen in 3D form and 3D space that were displayed through the display 210. For example, when the user's eyes are not tracked, the processor 250 may display only the first screen in 2D form through the display 210 without displaying the 3D space, instead of the first screen in 3D form and 3D space that were displayed through the display 210.

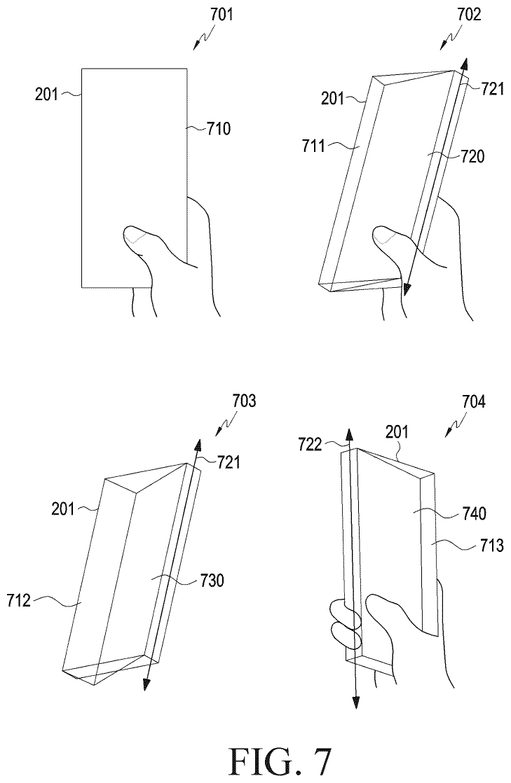

FIG. 7 is a diagram illustrating an example method of providing a three-dimensional screen using a first scheme according to various embodiments.

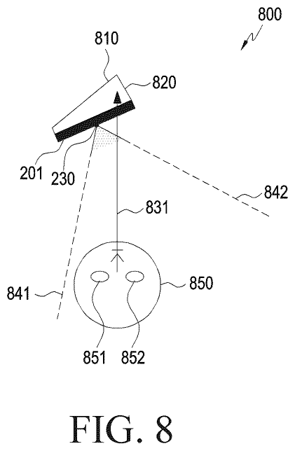

FIG. 8 is a diagram 800 illustrating an example method of providing a three-dimensional screen using a first scheme according to various embodiments.

In an embodiment, FIGS. 7 and 8 may be diagrams illustrating examples of rotating the first screen using the first scheme (negative scheme) when the electronic device 201 rotates. In FIGS. 7 and 8, the description will assume that the electronic device 201 is set to rotate the first screen using the first scheme when the electronic device 201 rotates.

Referring to FIGS. 7 and 8, in an embodiment, in reference numeral 701, the processor 250 may display the first screen 710 in 3D form through the display 210.

In an embodiment, in reference numeral 702, when the electronic device 201 is rotated clockwise by a first angle with respect to the right axis 721, the processor 250 may display, through the display 210, the first screen 720 rotated clockwise by a second angle greater than the first angle with respect to the right axis 721, together with a 3D space 711.

In an embodiment, in reference numeral 703, when the electronic device 201 is rotated clockwise by a third angle greater than the first angle with respect to the right axis 721, the processor 250 may display, through the display 210, the first screen 730 rotated clockwise by a fourth angle greater than the third angle with respect to the right axis 721, together with a 3D space 712 extending from the 3D space 711.

In an embodiment, in reference numeral 704, when the electronic device 201 is rotated counterclockwise by a fifth angle with respect to the left axis 722, the processor 250 may display, through the display 210, the first screen 740 rotated counterclockwise by a sixth angle greater than the fifth angle with respect to the left axis 722, together with a 3D space 713.

In an embodiment, FIG. 8 may represent a state in which the electronic device 201 is rotated counterclockwise with respect to the left axis of the electronic device 201.

In an embodiment, as illustrated in FIG. 8, when the electronic device 201 is rotated counterclockwise with respect to the left axis of the electronic device 201 while both eyes 851, 852 of a user 850 are tracked within the field of view range of the camera 230 (e.g., the space between lines 841, 842), the processor 250 may display, through the display 210, the rotated first screen 810 and 3D space 820 so that the 3D space 820 is visible by the gaze 831 of the user 850.

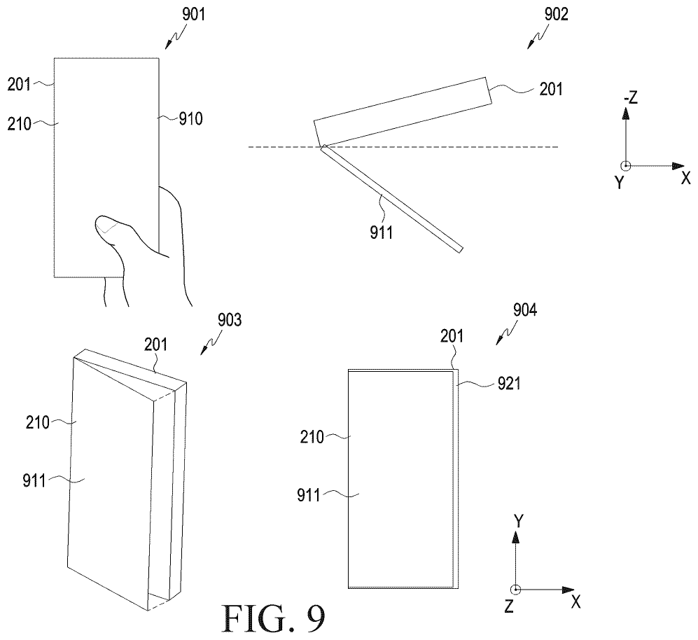

FIG. 9 is a diagram illustrating an example method of providing a three-dimensional screen using a second scheme according to various embodiments.

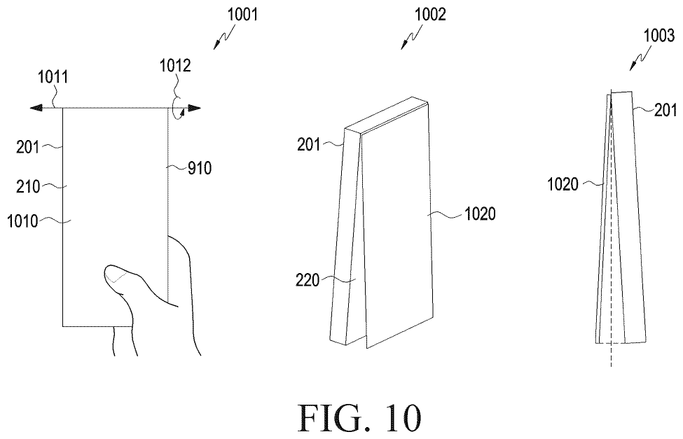

FIG. 10 is a diagram illustrating an example method of providing a three-dimensional screen using a second scheme according to various embodiments.

In an embodiment, FIGS. 9 and 10 may be views for describing examples of rotating the first screen using the second scheme (positive scheme) when the electronic device 201 rotates. In FIGS. 9 and 10, the description will assume that the electronic device 201 is set to rotate the first screen using the second scheme when the electronic device 201 rotates.

Referring to FIGS. 9 and 10, in an embodiment, in reference numeral 901, the processor 250 may display the first screen 910 in 3D form through the display 210.

In an embodiment, in reference numerals 902, 903, and 904, when the electronic device 201 is rotated counterclockwise by a first angle with respect to the left axis, the processor 250 may display, through the display 210, the first screen 911 rotated clockwise by a second angle greater than the first angle with respect to the left axis, together with a 3D space 921.

In an embodiment, in reference numeral 1001, the processor 250 may display the first screen 1010 in 3D form through the display 210.

In an embodiment, in reference numerals 1002 and 1003, when the electronic device 201 is rotated counterclockwise (e.g., in the direction indicated by arrow 1012) by a first angle with respect to the upper axis 1011, the processor 250 may display, through the display 210, the first screen 1020 rotated clockwise by a second angle greater than the first angle with respect to the upper axis 1011, together with a 3D space.

FIG. 11 is a diagram illustrating an example method of providing a three-dimensional screen according to various embodiments.

Referring to FIG. 11, as described above, in an embodiment, when the electronic device 201 is rotated with respect to an axis other than any one of the right axis, left axis, upper axis, and lower axis, the processor 250 may determine that the electronic device 201 has been rotated with respect to an axis that is parallel to the axis on which the electronic device 201 was rotated and closest in distance to the axis on which the electronic device 201 was rotated among the right axis, left axis, upper axis, and lower axis. The processor 250 may rotate the first screen with respect to the determined axis. However, the disclosure is not limited thereto.

In an embodiment, based on the axis on which the electronic device 201 rotates, the processor 250 may rotate the first screen with respect to the vertical center axis 223 (or horizontal center axis 513) in addition to the right axis, left axis, upper axis, or lower axis.

In an embodiment, the processor 250 may determine that the electronic device 201 has been rotated with respect to an axis that is parallel to the axis on which the electronic device 201 was rotated and closest in distance to the axis on which the electronic device 201 was rotated among the right axis, left axis, vertical center axis, upper axis, lower axis, and horizontal center axis of the electronic device 201.

In an embodiment, in reference numeral 1101, axis 1115 is an axis parallel to the left axis 1112 and vertical center axis 1113 and located between the left axis 1112 and vertical center axis 1113, and axis 1114 may be an axis parallel to the right axis 1111 and vertical center axis 1113 and located between the right axis 1111 and vertical center axis 1113.

In an embodiment, when the electronic device 201 is rotated with respect to axis 1115 and the distance between axis 1115 and left axis 1112 is shorter than the distance between axis 1115 and vertical center axis 1113, the processor 250 may determine that the electronic device 201 has been rotated with respect to the left axis 1112. When the electronic device 201 is rotated with respect to axis 1115 and the distance between axis 1115 and left axis 1112 is greater than the distance between axis 1115 and vertical center axis 1113, the processor 250 may determine that the electronic device 201 has been rotated with respect to the vertical center axis 1113.

In an embodiment, when the electronic device 201 is rotated with respect to axis 1114 and the distance between axis 1114 and right axis 1111 is shorter than the distance between axis 1114 and vertical center axis 1113, the processor 250 may determine that the electronic device 201 has been rotated with respect to the right axis 1111. When the electronic device 201 is rotated with respect to axis 1114 and the distance between axis 1114 and right axis 1111 is greater than the distance between axis 1114 and vertical center axis 1113, the processor 250 may determine that the electronic device 201 has been rotated with respect to the vertical center axis 1113.

In an embodiment, based on the area of the display 210 corresponding to (e.g., to which belongs) the axis on which the electronic device 201 rotates, the processor 250 may determine an axis serving as a reference for rotating the first screen from among the left axis, vertical center axis, upper axis, lower axis, and horizontal center axis. For example, the processor 250 may set axis 1114 including the boundary between areas 1111-1 and 1113-1 and axis 1115 including the boundary between areas 1112-1 and 1113-1 such that the size of area 1111-1 of the display 210, the size of area 1112-1, and the size of area 1113-1 are equal. When the axis on which the electronic device 201 rotates is parallel to the right axis 1111 and traverses area 1111-1, the processor 250 may determine the right axis 1111 as the axis serving as the reference for rotating the first screen. When the axis on which the electronic device 201 rotates is parallel to the vertical center axis 1113 and traverses area 1113-1, the processor 250 may determine the vertical center axis 1113 as the axis serving as the reference for rotating the first screen. When the axis on which the electronic device 201 rotates is parallel to the left axis 1112 and traverses area 1112-1, the processor 250 may determine the left axis 1112 as the axis serving as the reference for rotating the first screen.

In an embodiment, when rotating the first screen with respect to the vertical center axis (or horizontal center axis), the processor 250 may rotate a first portion of the first screen using the first scheme and rotate a second portion of the first screen using the second scheme.

In an embodiment, in reference numeral 1102, the processor 250 may display the first screen in 3D form through the display 210 before the electronic device 201 is rotated. For example, before the electronic device 201 is rotated, the first screen in 3D form may be provided to a user 1121.

In an embodiment, in reference numeral 1103, based on determining that the electronic device 201 has been rotated counterclockwise with respect to the vertical center axis 1113, the processor 250 may rotate the first screen using the second scheme for the first portion of the first screen (e.g., such that the first portion 1131 of the first screen 1130 is positioned in the front direction of the display 210) and rotate the first screen using the first scheme for the second portion of the first screen (e.g., such that the second portion 1132 of the first screen 1130 is positioned in the rear direction of the display 210) with respect to the vertical center axis 1113.

In an embodiment, in reference numeral 1104, based on determining that the electronic device 201 has been rotated clockwise with respect to the vertical center axis 1113, the processor 250 may rotate the first screen using the first scheme for the first portion of the first screen (e.g., such that the first portion 1141 of the first screen 1140 is positioned in the rear direction of the display 210) and rotate the first screen using the second scheme for the second portion of the first screen (e.g., such that the second portion 1142 of the first screen 1140 is positioned in the front direction of the display 210) with respect to the vertical center axis 1113.

In an embodiment, the processor 250 may rotate the first screen with respect to the vertical center axis 1113 in the same direction (or opposite direction) as the direction in which the electronic device 201 rotates with respect to the vertical center axis 1113.

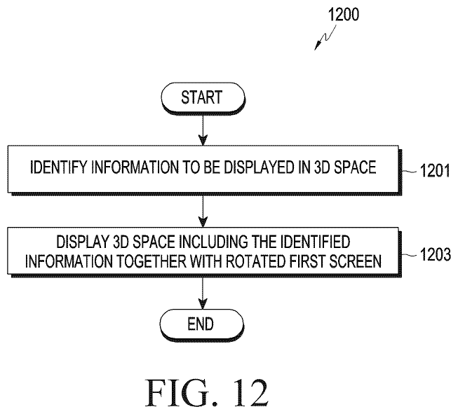

FIG. 12 is a flowchart 1200 for illustrating an example method of providing information in a 3D space according to various embodiments.

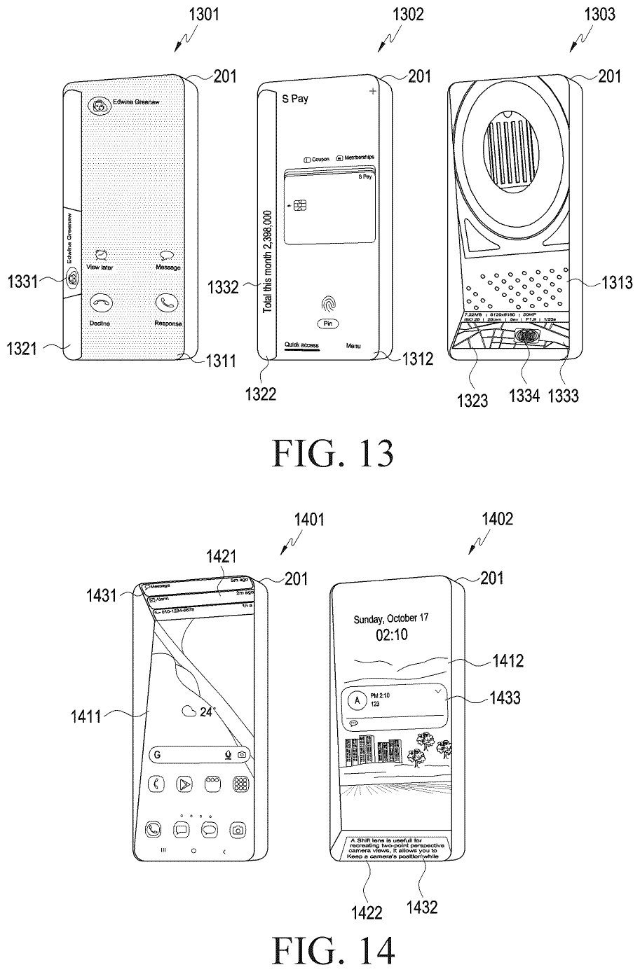

FIG. 13 is a diagram illustrating an example method of providing information in a 3D space according to various embodiments.

FIG. 14 is a diagram illustrating an example method of providing information in a 3D space according to various embodiments.

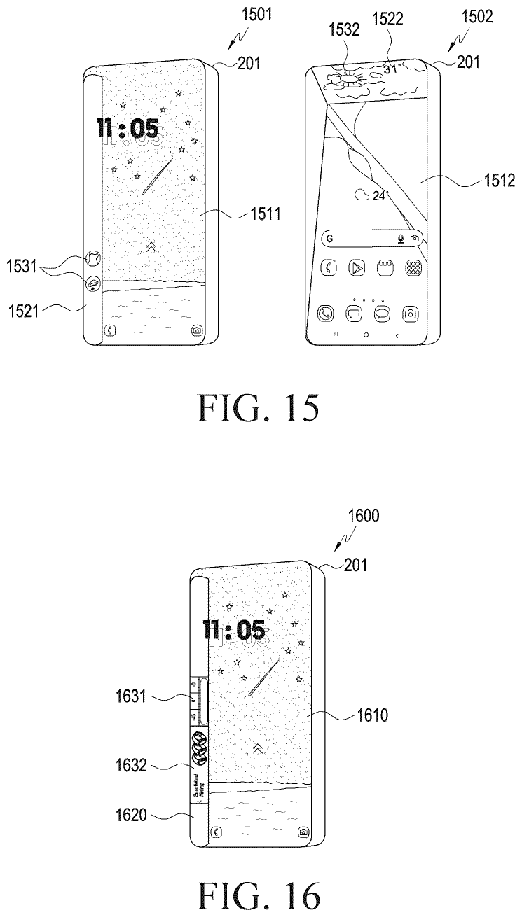

FIG. 15 is a diagram illustrating an example method of providing information in a 3D space according to various embodiments.

FIG. 16 is a diagram 1600 illustrating an example method of providing information in a 3D space according to various embodiments.

In an embodiment, FIGS. 12 to 16 may illustrate example operations included in operation 305 of FIG. 3 or operations performed after performing operation 305.

Referring to FIG. 12, in operation 1201, in an embodiment, the processor 250 may identify information to be displayed in a 3D space.

In an embodiment, after the electronic device 201 is rotated, the processor 250 may display, through the display 210, a 3D space including information together with the rotated first screen. For example, while the electronic device 201 is rotating or after the electronic device 201 is rotated, the processor 250 may identify information (e.g., object, image, text, and/or window) set to be displayed in the 3D space together with the rotated first screen.

In operation 1203, in an embodiment, the processor 250 may display, through the display 210, the 3D space including the identified information together with the rotated first screen.

Hereinafter, information included in the 3D space displayed together with the rotated first screen is described in greater detail with reference to FIGS. 13 to 16.

In an embodiment, information to be displayed in the 3D space may include information related to the first screen.

In an embodiment, information to be displayed in the 3D space may include information related to an application corresponding to the first screen.

In an embodiment, information related to an application corresponding to the first screen may include information related to the execution screen of the application (and/or functions of the application) and/or an execution screen of another application related to the application.

In an embodiment, in reference numeral 1301, while an execution screen of an application corresponding to the first screen is displayed (e.g., while a call reception screen is displayed by receiving a call from an external electronic device), the processor 250 may detect that the electronic device 201 is rotated clockwise with respect to the right axis of the electronic device 201. The processor 250 may rotate the first screen (e.g., call reception screen) by a rotation angle greater than the rotation angle of the electronic device 201 clockwise with respect to the right axis using the first scheme (negative scheme). The processor 250 may display, through the display 210, a 3D space 1321 including information 1331 about a counterpart who made the call (e.g., counterpart's name, counterpart's phone number, and/or counterpart's photo) as information related to the execution screen of the phone application, together with the rotated first screen 1311.

In an embodiment, in reference numeral 1302, while an execution screen of an application corresponding to the first screen is displayed (e.g., while an execution screen of a payment application is displayed), the processor 250 may detect that the electronic device 201 is rotated clockwise with respect to the right axis of the electronic device 201. The processor 250 may rotate the first screen (e.g., execution screen of the payment application) by a rotation angle greater than the rotation angle of the electronic device 201 clockwise with respect to the right axis using the first scheme. The processor 250 may display, through the display 210, a 3D space 1322 including information 1332 about cumulative usage amount of a card used for payment as information related to the execution screen of the payment application (or information related to functions of the payment application), together with the rotated first screen 1312.

In an embodiment, in reference numeral 1303, while an execution screen of a first application (e.g., gallery application) corresponding to the first screen is displayed (e.g., while an execution screen of a gallery application is displayed), the processor 250 may detect that the electronic device 201 is rotated counterclockwise with respect to the upper axis of the electronic device 201. The processor 250 may rotate the first screen (e.g., execution screen of the gallery application) by a rotation angle greater than the rotation angle of the electronic device 201 counterclockwise with respect to the upper axis using the first scheme. The processor 250 may display, through the display 210, a 3D space 1323 including an execution screen 1333 of a map application (e.g., a map including an object 1334 indicating a location where an image included in the execution screen of the gallery application was captured) as a second application related to the first application, together with the rotated first screen 1313.

In an embodiment, information to be displayed in the 3D space may include information related to information (e.g., notification and/or message) received from an external electronic device while the first screen is displayed.

In an embodiment, in reference numeral 1401, while a home screen is displayed as the first screen, the processor 250 may detect that the electronic device 201 is rotated clockwise with respect to the lower axis of the electronic device 201. The processor 250 may rotate the first screen (e.g., home screen) by a rotation angle greater than the rotation angle of the electronic device 201 clockwise with respect to the lower axis using the first scheme. The processor 250 may display, through the display 210, a 3D space 1421 including a notification 1431 received from an external electronic device, together with the rotated first screen 1411.

In an embodiment, in reference numeral 1402, while a lock screen is displayed as the first screen, the processor 250 may detect that the electronic device 201 is rotated counterclockwise with respect to the upper axis of the electronic device 201. The processor 250 may rotate the first screen (e.g., lock screen) by a rotation angle greater than the rotation angle of the electronic device 201 counterclockwise with respect to the upper axis using the first scheme. When a message is received from an external electronic device after the electronic device 201 is rotated, the processor 250 may display, through the display 210, information 1433 about a user of the external electronic device that sent the message on the rotated first screen 1412, and display a message 1432 received from the external electronic device within the 3D space 1422.

In an embodiment, information to be displayed in the 3D space may include information set by a user (e.g., based on user input).

In an embodiment, in reference numeral 1501, while a lock screen is displayed as the first screen, the processor 250 may detect that the electronic device 201 is rotated clockwise with respect to the right axis of the electronic device 201. The processor 250 may rotate the first screen (e.g., lock screen) by a rotation angle greater than the rotation angle of the electronic device 201 clockwise with respect to the right axis using the first scheme. The processor 250 may display, through the display 210, a 3D space 1521 including an object 1531 (e.g., icon) corresponding to an application set to be displayed in the 3D space by a user input, together with the rotated first screen 1511.

In an embodiment, information to be displayed in the 3D space may include information set by default to be displayed in the 3D space when the first screen is displayed.

In an embodiment, in reference numeral 1502, while a home screen is displayed as the first screen, the processor 250 may detect that the electronic device 201 is rotated clockwise with respect to the lower axis of the electronic device 201. The processor 250 may rotate the first screen (e.g., home screen) by a rotation angle greater than the rotation angle of the electronic device 201 clockwise with respect to the lower axis using the first scheme. The processor 250 may display, through the display 210, a 3D space 1522 including an object 1532 (e.g., weather widget) set by default to be displayed in the 3D space when the home screen is displayed, together with the rotated first screen 1512.

In an embodiment, referring to FIG. 16, information to be displayed in the 3D space may include advertisements. For example, while a lock screen is displayed as the first screen, the processor 250 may detect that the electronic device 201 is rotated clockwise with respect to the right axis of the electronic device 201. The processor 250 may rotate the first screen (e.g., lock screen) by a rotation angle greater than the rotation angle of the electronic device 201 clockwise with respect to the right axis using the first scheme. The processor 250 may display, through the display 210, a 3D space 1620 including one or more advertisements 1631, 1632, together with the rotated first screen 1610.

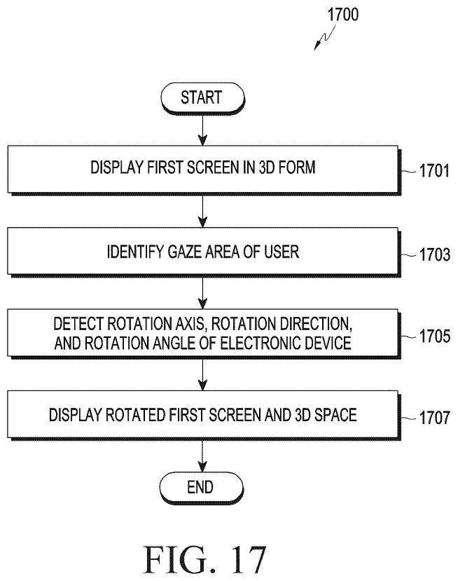

FIG. 17 is a flowchart 1700 illustrating an example method of providing information in a 3D space according to various embodiments.

FIG. 18 is a diagram illustrating an example method of providing information in a 3D space according to various embodiments.

Referring to FIGS. 17 and 18, in operation 1701, in an embodiment, the processor 250 may display a first screen in 3D form through the display 210.

Operation 1701 is at least partially identical or similar to operation 301 of FIG. 3, so detailed description may not be repeated here.

In operation 1703, in an embodiment, the processor 250 may identify a gaze area (or gaze position) of a user. For example, the processor 250 may identify, using the camera 230 (and depth sensor), a gaze area where the user's eyes gaze within the display 210 (and a gaze direction in which the user's eyes gaze relative to the direction in which the electronic device 201 (e.g., the display 210) faces).

In operation 1705, in an embodiment, the processor 250 may detect a rotation axis, a rotation direction, and a rotation angle of the electronic device 201 through the inertial sensor 220 based on the electronic device 201 being rotated while the first screen is displayed.

Operation 1705 is at least partially identical or similar to operation 303 of FIG. 3, so detailed description may not be repeated here.

In operation 1707, in an embodiment, the processor 250 may display, through the display 210, the first screen rotated based on the rotation axis, the rotation direction, the rotation angle, and the gaze area (e.g., the gaze area identified through operation 1703) of the electronic device 201, and a 3D space which has not been displayed through the display 210 before the electronic device 201 rotates.

Hereinafter, descriptions overlapping operation 305 of FIG. 3 may not be repeated.

In an embodiment, the processor 250 may select a scheme for rotating the first screen from among the first scheme and the second scheme based on the rotation axis, rotation direction, and/or gaze area of the electronic device 201.

In an embodiment, referring to FIG. 18 and reference numerals 1801 and 1802, when the gaze area identified by gaze 1811 is included in the right area of the display 210 (e.g., the area of the display 210 corresponding to the rotation axis of the display 210) and the electronic device 201 rotates clockwise with respect to the right axis, the processor 250 may determine the second scheme, which positions the rotated first screen 1812 in the front direction of the electronic device 201 (or the display 210), as the scheme for rotating the first screen. In an embodiment, when the gaze area identified by gaze 1811 is included in the right area of the display 210 and the electronic device 201 rotates counterclockwise with respect to the right axis, the processor 250 may determine the first scheme as the scheme for rotating the first screen.

In an embodiment, referring to reference numerals 1803 and 1804, when the gaze area identified by gaze 1821 is included in the left area of the display 210 (e.g., the area opposite to the area of the display 210 corresponding to the rotation axis of the display 210) and the electronic device 201 rotates clockwise with respect to the left axis, the processor 250 may determine the first scheme, which positions the rotated first screen 1822 in the rear direction of the electronic device 201 (or the display 210), as the scheme for rotating the first screen. In an embodiment, when the gaze area identified by gaze 1821 is included in the left area of the display 210 and the electronic device 201 rotates counterclockwise with respect to the left axis, the processor 250 may determine the second scheme as the scheme for rotating the first screen.

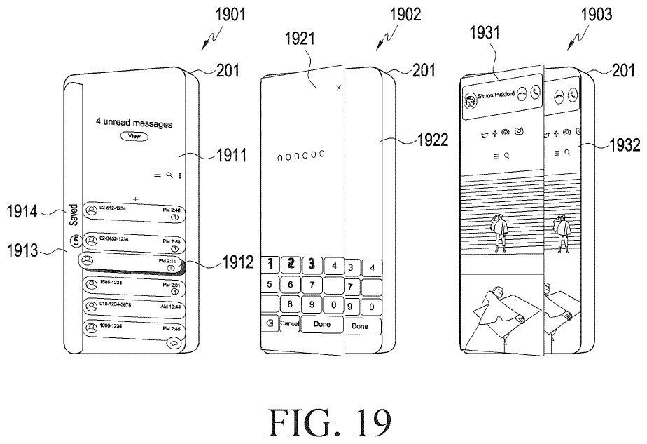

FIG. 19 is a diagram illustrating an example method of providing information in a 3D space according to various embodiments.

Referring to FIG. 19, in an embodiment, based on the electronic device 201 being rotated, the processor 250 may move at least one object (e.g., icon) included in the first screen from the first screen (e.g., the first screen displayed in 3D form) to the 3D space. For example, in reference numeral 1901, the processor 250 may display the rotated first screen 1911 and 3D space 1913 through the display 210. The processor 250 may select at least one object 1912 from among one or more objects included in the first screen 1911 based on user input. As the electronic device 201 is rotated clockwise with respect to the right axis, the processor 250 may rotate the first screen 1911 using the first scheme and display an extended 3D space through the display 210. The processor 250 may move the selected object 1912 to the extended 3D space. Based on the selected object 1912 being moved to the extended 3D space, the processor 250 may display, through the display 210, information 1914 indicating that the selected object 1912 has been moved to the 3D space including the selected object 1912.

However, the disclosure is not limited thereto. In an embodiment, based on the electronic device 201 being rotated, the processor 250 may move at least one object included in the 3D space from the 3D space to the first screen (e.g., the first screen displayed in 3D form). For example, the processor 250 may display the rotated first screen and a 3D space including one or more objects through the display 210. The processor 250 may select at least one object from among one or more objects included in the 3D space based on user input. As the electronic device 201 is rotated counterclockwise with respect to the right axis, the processor 250 may rotate the first screen counterclockwise using the first scheme and display a decreased 3D space through the display 210. The processor 250 may move the selected object from the decreased 3D space to the first screen.

In an embodiment, when rotating the first screen, the processor 250 may change attributes of the first screen. For example, in reference numeral 1902, while an execution screen of an application designated by a user input or requiring security (e.g., a password input screen) is displayed through the display 210 as the first screen 1921, the processor 250 may detect that the electronic device 201 is rotated counterclockwise with respect to the left axis of the electronic device 201. The processor 250 may display, through the display 210, the first screen 1921 rotated using the second scheme and having a lower brightness level compared to the brightness level before rotation (e.g., the first screen darker than the first screen before rotation) together with the 3D space 1922.

In an embodiment, the second scheme may enable eye tracking for a user to be maintained. For example, in reference numeral 1903, the processor 250 may display the first screen 1931 in 3D form through the display 210 based on a first user's eyes being tracked. When a second user approaches from the left of the first user while the first screen is displayed in 3D form through the display 210, the eyes of the first user and the eyes of the second user may be positioned within the field of view range of the camera 230. In this case, eye tracking may not be maintained (when multiple users' eyes are recognized, eye tracking may not be performed). When the first user rotates the electronic device 201 counterclockwise with respect to the left axis, the processor 250 may rotate the first screen clockwise using the second scheme (e.g., rotating such that the eyes of the second user are not positioned within the field of view range of the camera 230 and only the eyes of the first user are positioned within the field of view range of the camera 230), thereby making an area 1932 corresponding to the axis opposite to the rotation axis of the first screen (e.g., the left axis of the first screen) (e.g., an area corresponding to the right axis of the first screen) within the first screen appear larger to the first user (and second user) and enabling eye tracking.

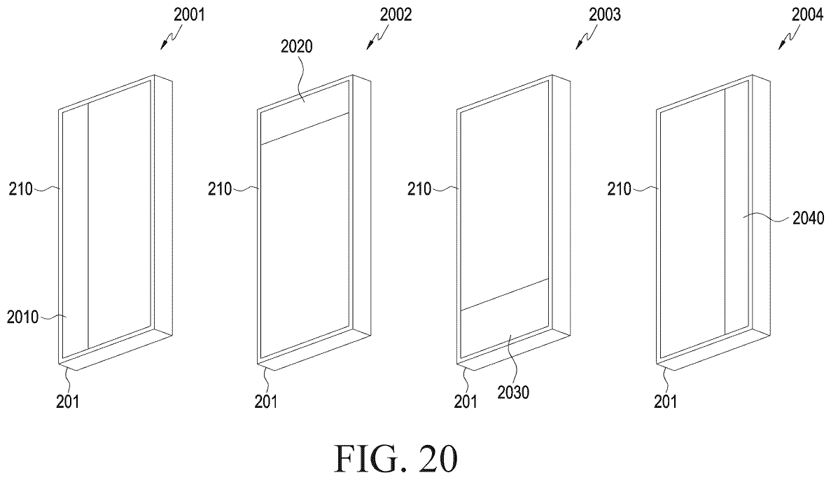

FIG. 20 is a diagram illustrating an example optical configuration for a 3D screen according to various embodiments.

Referring to FIG. 20, in an embodiment, as described through FIG. 2, the display 210 may be the display 210 capable of supporting (e.g., displaying) a 3D screen using a glasses-free method. For example, the display 210 may display a three-dimensional screen using a lenticular lens disposed in front of the display 210 panel. For example, the display 210 may display a three-dimensional screen using a parallax barrier disposed in front of the display 210 panel.

In an embodiment, an optical configuration (e.g., lenticular lens or parallax barrier) that enables the display 210 to display a 3D screen may be disposed in the entire area or a partial area of the display 210. For example, as illustrated in reference numeral 2001, the display 210 may include an optical configuration 2010 disposed in the left area of the display 210. For example, as illustrated in reference numeral 2002, the display 210 may include an optical configuration 2020 disposed in the upper area of the display 210. For example, as illustrated in reference numeral 2003, the display 210 may include an optical configuration 2030 disposed in the lower area of the display 210. For example, as illustrated in reference numeral 2004, the display 210 may include an optical configuration 2040 disposed in the right area of the display 210. However, the position within the display 210 where the optical configuration is disposed is not limited to the positions described through reference numerals 2001 to 2004.

In an embodiment, when an optical configuration (e.g., lenticular lens or parallax barrier) is disposed in a partial area of the display 210, the display 210 may display a 3D screen in the partial area and display a 2D screen in an area of the display 210 where the optical configuration is not disposed.

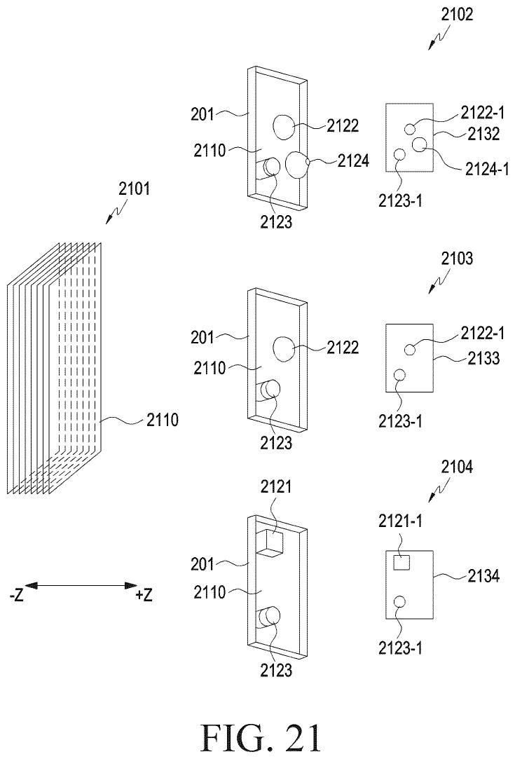

FIG. 21 is a diagram illustrating an example method of controlling an object included in a first screen according to various embodiments.

Referring to FIG. 21, in an embodiment, the processor 250 may display a first screen including one or more objects displayed in 3D form (hereinafter, an object displayed in 3D form is referred to as “3D object”) through the display 210. When the first screen includes multiple 3D objects, it may be difficult for a user to select one 3D object from among the multiple 3D objects.

In an embodiment, in reference numeral 2101, based on user input, the processor 250 may set a window 2110 (hereinafter referred to as “virtual window”) that may move in the front direction (e.g., +Z direction) in which the display 210 faces or the rear direction (e.g., −Z direction) which is the opposite direction to the front direction.

In an embodiment, the processor 250 may select a 3D object included in the first screen by moving a virtual window by a designated depth (e.g., distance on the Z axis) in the front direction or the rear direction.

In an embodiment, at least some of one or more 3D objects included in the first screen may have different lengths on the axis on which the virtual window moves.

In an embodiment, at least some of one or more 3D objects included in the first screen may have different positions on the axis on which the virtual window moves.

In an embodiment, in reference numeral 2102, the processor 250 may select a 3D object disposed at the same position as the position of the virtual window on the axis on which the virtual window moves. For example, the processor 250 may select an object 2122, an object 2123, and an object 2124 disposed at the same position as the position of the virtual window 2110 (e.g., in contact with the surface forming the virtual window 2110 or traversed by the surface forming the virtual window 2110). In an embodiment, the processor 250 may change a selected 3D object to a 2D object and display the first screen including the 2D object among one or more objects included in the first screen through the display 210. For example, in reference numeral 2102, the processor 250 may display, through the display 210, the first screen 2132 including 2D objects (e.g., object 2122-1, object 2123-1, and object 2124-1) corresponding to the selected object 2122, object 2123, and object 2124.

In an embodiment, in reference numeral 2103, based on user input, the processor 250 may move the virtual window 2110 in the −Z-axis direction. The processor 250 may select an object 2122 and an object 2123 disposed at the same position as the position of the virtual window 2110. In reference numeral 2103, the processor 250 may display, through the display 210, the first screen 2133 including object 2122-1 and object 2123-1 corresponding to the selected object 2122 and object 2123.

In an embodiment, in reference numeral 2104, based on user input, the processor 250 may further move the virtual window 2110 in the −Z-axis direction. The processor 250 may select an object 2121 and an object 2123 disposed at the same position as the position of the virtual window 2110. In reference numeral 2104, the processor 250 may display, through the display 210, the first screen 2134 including object 2121-1 and object 2123-1 corresponding to the selected object 2121 and object 2123.

In an embodiment, when multiple objects are selected by a virtual window, the processor 250 may select one object from among the multiple objects based on user input.

In an embodiment, when the position of a virtual window is maintained the same as the position of one object for a designated time, the processor 250 may select that one object.

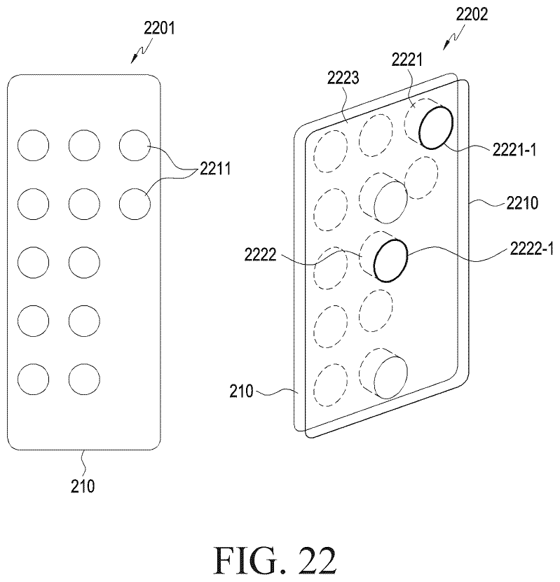

FIG. 22 is a diagram illustrating an example method of controlling an object included in a first screen according to various embodiments.

Referring to FIG. 22, in an embodiment, as described through FIG. 21, at least some of one or more 3D objects included in the first screen may have different lengths on the axis on which the virtual window moves.

In an embodiment, the processor 250 may set a length with respect to the axis on which the virtual window moves for a 3D object (hereinafter referred to as “length of 3D object”).

In an embodiment, the processor 250 may set the length of a 3D object based on the number of times an application corresponding to the 3D object (or 2D object corresponding to the 3D object) has been executed (and/or the total time the application has been executed). For example, the processor 250 may set a 3D object such that the more times an application corresponding to the 3D object (or 2D object corresponding to the 3D object) has been executed (and/or the longer the total time the application has been executed), the longer the length of the 3D object.

In an embodiment, the processor 250 may set the length of a 3D object based on the date and/or time when an application corresponding to the 3D object (or 2D object corresponding to the 3D object) was executed. For example, the processor 250 may set a 3D object such that the more recent the time when an application corresponding to the 3D object (or 2D object corresponding to the 3D object) was executed from the current time, the longer the length of the 3D object.

In an embodiment, when a favorites function is set for an application corresponding to a 3D object (or 2D object corresponding to the 3D object), the processor 250 may set a 3D object such that the length of the 3D object corresponding to an application with the favorites function set is longer than the length of a 3D object corresponding to an application without the favorites function set.

In an embodiment, in reference numeral 2201, the processor 250 may display a first screen including 3D objects 2211 through the display 210.

In an embodiment, by moving a virtual window 2223 based on user input, the processor 250 may select at least one object from among 3D objects 2211 that have at least partially different lengths. For example, in reference numeral 2202, the processor 250 may select an object 2221 traversed by the surface forming the virtual window 2223 and an object 2222 in contact with the surface forming the virtual window 2223. In this case, the processor 250 may display indications 2221-1, 2222-1 indicating that the object 2221 and object 2222 are selected through the display 210.

The electronic device 201 according to an example embodiment may include the display 210 supporting a 3D screen, an inertial sensor 220, at least one processor 250, and memory 240 storing instructions. The instructions may, when executed by the at least one processor 250, cause the electronic device 201 to display a first screen in a 3D form through the display 210. The instructions may, when executed by the at least one processor 250, cause the electronic device 201 to detect, through the inertial sensor 220, a rotation axis, a rotation direction, and a rotation angle of the electronic device 201 based on the electronic device 201 being rotated while the first screen is displayed. The instructions may, when executed by the at least one processor 250, cause the electronic device 201 to display, through the display 210, the first screen rotated based on the rotation axis, the rotation direction, and the rotation angle of the electronic device 201 and a 3D space which has not been displayed through the display 210.

In an example embodiment, the instructions may, when executed by the at least one processor 250, cause the electronic device 201 to rotate the first screen by an angle greater than the rotation angle in the rotation direction or an opposite direction to the rotation direction with respect to a rotation axis corresponding to the rotation axis, based on the rotation axis, the rotation direction, and the rotation angle of the electronic device 201.

In an example embodiment, the instructions may, when executed by the at least one processor 250, cause the electronic device 201 to rotate the first screen using a first scheme to rotate the first screen such that the first screen is positioned in a second direction which is an opposite direction to a first direction in which the display 210 faces after the electronic device 201 is rotated.

In an example embodiment, the instructions may, when executed by the at least one processor 250, cause the electronic device 201 to rotate the first screen using a second scheme to rotate the first screen such that the first screen is positioned in a first direction in which the display 210 faces after the electronic device 201 is rotated.

In an example embodiment, the 3D space may be a space in 3D form excluding the first screen from a second screen including the rotated first screen and the 3D space.

In an example embodiment, the instructions may, when executed by the at least one processor 250, cause the electronic device 201 to identify information to be displayed in the 3D space. The instructions may, when executed by the at least one processor 250, cause the electronic device 201 to display, through the display 210, the 3D space including the identified information together with the rotated first screen.

In an example embodiment, the information to be displayed in the 3D space may include information related to an application corresponding to the first screen.

In an example embodiment, the information to be displayed in the 3D space may include information set based on user input of the electronic device 201 and/or an advertisement.

In an example embodiment, the electronic device 201 may further include a camera 230. The instructions may, when executed by the at least one processor 250, cause the electronic device 201 to identify a gaze area of a user of the electronic device 201 using the camera 230. The instructions may, when executed by the at least one processor 250, cause the electronic device 201 to display, through the display 210, the 3D space and the first screen rotated based on the rotation axis, the rotation direction, the rotation angle of the electronic device 201, and the gaze area.

In an example embodiment, the display 210 may be a display including a lenticular lens or a parallax barrier, or a light field display.

In an example embodiment, a method of providing a three-dimensional screen in the electronic device 201 may include displaying a first screen in a 3D form through the display 210 included in the electronic device 201 and supporting a 3D screen. The method may include detecting, through the inertial sensor 220 of the electronic device 201, a rotation axis, a rotation direction, and a rotation angle of the electronic device 201 based on the electronic device 201 being rotated while the first screen is displayed. The method may include displaying, through the display 210, the first screen rotated based on the rotation axis, the rotation direction, and the rotation angle of the electronic device 201 and a 3D space which has not been displayed through the display 210.

In an example embodiment, displaying the rotated first screen and the 3D space may include rotating the first screen by an angle greater than the rotation angle in the rotation direction or an opposite direction to the rotation direction with respect to a rotation axis corresponding to the rotation axis, based on the rotation axis, the rotation direction, and the rotation angle of the electronic device 201.

In an example embodiment, displaying the rotated first screen and the 3D space may include rotating the first screen using a first scheme to rotate the first screen such that the first screen is positioned in a second direction which is an opposite direction to a first direction in which the display 210 faces after the electronic device 201 is rotated.

In an example embodiment, displaying the rotated first screen and the 3D space may include rotating the first screen using a second scheme to rotate the first screen such that the first screen is positioned in a first direction in which the display 210 faces after the electronic device 201 is rotated.

In an example embodiment, the 3D space may be a space in 3D form excluding the first screen from a second screen including the rotated first screen and the 3D space.

In an example embodiment, displaying the rotated first screen and the 3D space may include identifying information to be displayed in the 3D space and displaying, through the display 210, the 3D space including the identified information together with the rotated first screen.

In an example embodiment, the information to be displayed in the 3D space may include information related to an application corresponding to the first screen.

In an example embodiment, the information to be displayed in the 3D space may include information set based on user input of the electronic device 201 and/or an advertisement.

In an example embodiment, displaying the rotated first screen and the 3D space may include identifying a gaze area of a user of the electronic device 201 using the camera 230 of the electronic device 201 and displaying, through the display 210, the 3D space and the first screen rotated based on the rotation axis, the rotation direction, the rotation angle of the electronic device 201, and the gaze area.

In an example embodiment, the display 210 may be a display including a lenticular lens or a parallax barrier, or a light field display.

In an example embodiment, in a non-transitory computer-readable medium storing computer-executable instructions, the computer-executable instructions may, when executed by at least one processor 250 of an electronic device 201, cause the electronic device 201 to display a first screen in a 3D form through the display 210 included in the electronic device 201 and supporting a 3D screen. The computer-executable instructions may, when executed by at least one processor 250 of the electronic device 201, cause the electronic device 201 to detect, through the inertial sensor 220 of the electronic device 201, a rotation axis, a rotation direction, and a rotation angle of the electronic device 201 based on the electronic device 201 being rotated while the first screen is displayed. The computer-executable instructions may, when executed by at least one processor 250 of the electronic device 201, cause the electronic device 201 to display, through the display 210, the first screen rotated based on the rotation axis, the rotation direction, and the rotation angle of the electronic device 201 and a 3D space which has not been displayed through the display 210.

Further, the structure of the data used in embodiments of the disclosure may be recorded in a computer-readable recording medium via various means. The computer-readable recording medium may include, for example, and without limitation, a storage medium, such as a magnetic storage medium (e.g., a ROM, a floppy disc, or a hard disc) or an optical reading medium (e.g., a CD-ROM or a DVD).

While the disclosure has been illustrated and described with reference to various example embodiments, it will be understood that the various example embodiments are intended to be illustrative, not limiting. It will be further understood by those skilled in the art that various modifications, alternatives and/or variations of the various example embodiments may be made without departing from the true technical spirit and full technical scope of the disclosure, including the appended claims and their equivalents. It will also be understood that any of the embodiment(s) described herein may be used in conjunction with any other embodiment(s) described herein.

What is claimed is:

1. An electronic device, comprising:
a display configured to support a 3D screen;
an inertial sensor;
at least one processor, comprising processing circuitry; and
memory storing instructions that, when executed by the at least one processor individually or collectively, cause the electronic device to:
display a first screen in a 3D form through the display,
based on the electronic device being rotated while the first screen is displayed, detect, through the inertial sensor, a rotation axis, a rotation direction, and a rotation angle of the electronic device, and
display, through the display, the first screen rotated based on the rotation axis, the rotation direction, and the rotation angle of the electronic device and a 3D space which has not been displayed through the display.

2. The electronic device of claim 1, wherein the instructions, when executed by the at least one processor individually or collectively, cause the electronic device to:
based on the rotation axis, the rotation direction, and the rotation angle of the electronic device, rotate, with respect to a rotation axis corresponding to the rotation axis, the first screen by an angle greater than the rotation angle in the rotation direction or an opposite direction to the rotation direction.

3. The electronic device of claim 1, wherein the instructions, when executed by the at least one processor individually or collectively, cause the electronic device to rotate the first screen using a first scheme to rotate the first screen such that the first screen is positioned in a second direction opposite to a first direction in which the display faces after the electronic device is rotated.

4. The electronic device of claim 1, wherein the instructions, when executed by the at least one processor individually or collectively, cause the electronic device to rotate the first screen using a second scheme to rotate the first screen such that the first screen is positioned in a first direction in which the display faces after the electronic device is rotated.

5. The electronic device of claim 1, wherein the 3D space is a 3D space of a second screen including the rotated first screen and the 3D space, excluding the first screen.

6. The electronic device of claim 1, wherein the instructions, when executed by the at least one processor individually or collectively, cause the electronic device to:
identify information to be displayed in the 3D space, and
display, through the display, the 3D space including the identified information together with the rotated first screen.

7. The electronic device of claim 6, wherein the information to be displayed in the 3D space includes information related to an application corresponding to the first screen.

8. The electronic device of claim 6, wherein the information to be displayed in the 3D space includes information set based on an input of the electronic device and/or an advertisement.

9. The electronic device of claim 1, further comprising a camera,
wherein the instructions, when executed by the at least one processor individually or collectively, cause the electronic device to:
identify, using the camera, a gaze area of a user of the electronic device, and
display, through the display, the 3D space and the first screen rotated based on the rotation axis, the rotation direction, the rotation angle of the electronic device, and the gaze area.

10. The electronic device of claim 1, wherein the display comprises a display including a lenticular lens or a parallax barrier, or a light field display.

11. A method of providing a 3D (three-dimensional) screen in an electronic device, the method comprising:
displaying a first screen in a 3D form through a display included in the electronic device and supporting a 3D screen;
based on the electronic device being rotated while the first screen is displayed, detecting, through an inertial sensor of the electronic device, a rotation axis, a rotation direction, and a rotation angle of the electronic device; and
displaying, through the display, the first screen rotated based on the rotation axis, the rotation direction, and the rotation angle of the electronic device and a 3D space which has not been displayed through the display.

12. The method of claim 11, wherein displaying the rotated first screen and the 3D space comprises:
rotating, with respect to a rotation axis corresponding to the rotation axis, the first screen by an angle greater than the rotation angle in the rotation direction or an opposite direction to the rotation direction based on the rotation axis, the rotation direction, and the rotation angle of the electronic device.

13. The method of claim 11, wherein displaying the rotated first screen and the 3D space comprises:
rotating the first screen using a first scheme to rotate the first screen such that the first screen is positioned in a second direction opposite to a first direction in which the display faces after the electronic device is rotated.

14. The method of claim 11, wherein displaying the rotated first screen and the 3D space comprises:
rotating the first screen using a second scheme to rotate the first screen such that the first screen is positioned in a first direction in which the display faces after the electronic device is rotated.

15. The method of claim 11, wherein the 3D space is a 3D space of a second screen including the rotated first screen and the 3D space, excluding the first screen.

16. The method of claim 11, wherein displaying the rotated first screen and the 3D space comprises:
identifying information to be displayed in the 3D space; and
displaying, through the display, the 3D space including the identified information together with the rotated first screen.

17. The method of claim 16, wherein the information to be displayed in the 3D space includes information related to an application corresponding to the first screen.

18. The method of claim 16, wherein the information to be displayed in the 3D space includes information set based on an input of the electronic device and/or an advertisement.

19. The method of claim 11, wherein displaying the rotated first screen and the 3D space comprises:
identifying, using a camera of the electronic device, a gaze area of a user of the electronic device, and
displaying, through the display, the 3D space and the first screen rotated based on the rotation axis, the rotation direction, the rotation angle of the electronic device, and the gaze area.

20. A non-transitory computer-readable medium storing computer-executable instructions that, when executed by at least one processor, comprising processing circuitry, of an electronic device, individually and/or collectively, cause the electronic device to:
display a first screen in a 3D form through a display included in the electronic device and supporting a 3D screen,
based on the electronic device being rotated while the first screen is displayed, detect, through an inertial sensor of the electronic device, a rotation axis, a rotation direction, and a rotation angle of the electronic device, and
display, through the display, the first screen rotated based on the rotation axis, the rotation direction, and the rotation angle of the electronic device and a 3D space which has not been displayed through the display.
